(19) United States
(12) Patent Application Publication
(10) Pub. No.: US 2005/0245121 A1
(43) Pub. Date: Nov. 3, 2005

(54) Solder ball formation structure for a terminal socket

(75) Inventor: Jui-Hsiang Lin, Taipei (TW)

Correspondence Address: TROXELL LAW OFFICE PLLC;Suite 1404, 5205 Leesburg Pike, Falls Church, VA, 22041, US

(73) Assignee: Ronmee Industrial Corporation

(21) Appl. No.: 10/833,075

(22) Filed: Apr. 28, 2004

(51) Int. Cl. H01R 12/00

(52) U.S. Cl. 439/342

(57) ABSTRACT

The present invention is related to a solder ball formation structure for terminal socket, on top of which there is a contact end that extends downward to a extension, and at the end of the terminal socket the wire socket is combined with solder ball. The wire socket appears spherical and curves up. When the curved surface touches the heated solder, the solder is transferred to the curved surface and forms near-spherical solder ball through increasing cohesive force by raising the terminal up. The solder ball sticks to the bottom of the soldering area. The solder balls underneath the terminal through a simple and easy process are uniformly produced, so the quality of the connector is improved by assuring that the solder balls receive the same amount of heat when the connector is attached to a circuit board.

### BACKGROUND OF THE INVENTION

1. Field of the Invention

The invention is related to the solder ball formation structure for a terminal socket of a connector. Especially, it means a terminal socket that goes through a simple process to have adhered solder balls with reduced cost and improved connector density.

The connector used in a CPU and a circuit board has the terminals for electric connection purpose. With technical progress, surface mount terminals are extensively used. Solder is applied to terminal pins, so the terminal can be attached to a circuit board.

2. Description of the Related Art

As shown in FIG. 1, the terminal 10 extends to its bottom to have a terminal end 101 that is attached with a solder ball 20. After heating up a certain temperature, the solder ball 20 melts and enables the terminal 10 to attach to a circuit board. Because the terminal size is small, the attached solder ball 10 is also very small. Solder ball 20 is made from a complicated process and has a high cost. Besides, the accurate solder ball 20 location depends on a reliable soldering technology. Otherwise, the connector quality will deteriorate due to poor electric connection.

As shown in FIG. 2, the end of the terminal 30 has a through-hole (not shown in the Figure), where solder 40 is placed in, and so both ends of the solder stick out to a certain length. Then through a compression process with molds 50, the solder 40 is firmly attached to the terminal 30. However, such a process requires a very precise compression machine to attach the solder to the terminal. In other words, it requires high level of technology. If compression is not performed with accuracy and precision, the molding effect will be very poor.

### SUMMARY OF THE INVENTION

In view of the shortcomings for a traditional solder structure in the aspect of either material cost or processing technology, the inventor of the present invention with many years of experience in this field sought improvement on solder structure in the terminal end and now is able to provide an improved solder ball structure for the terminal socket to benefit the industry.

The main objective of the present invention is to provide a solder formation structure that is different from the traditional solder ball structure. Especially, it provides a solder ball structure with a simple process, a reduced cost and easy operation.

The main feature of the present invention is to make the soldering area at a terminal end into spherical shape with curved surface, which when contacts heated solder can make the solder spherical through raised cohesive force. The solder attachment and formation process is simple and enables direct adherence of solder to the soldering area of a terminal socket. Thus, the present invention saves solder application time, reduces the cost significantly and also improves the connector quality.

### BRIEF DESCRIPTION OF THE DRAWINGS

FIG. 1 is an illustration for how solder is placed on a traditional terminal.

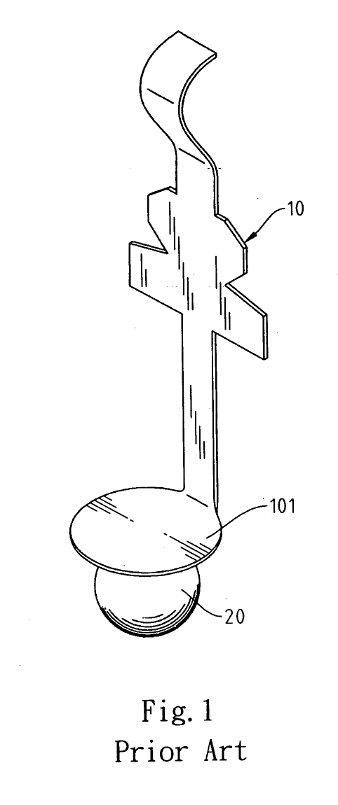

FIG. 2 is another illustration for how solder is placed on a traditional terminal.

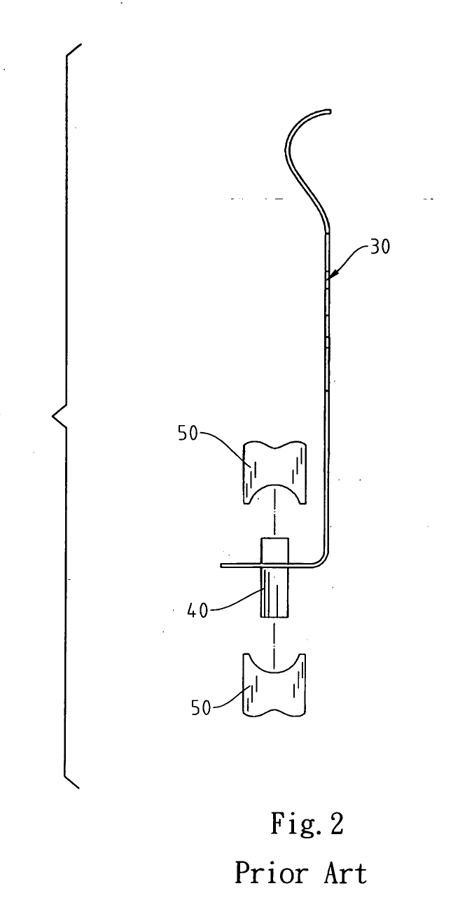

FIG. 3 is the three-dimensional diagram of the terminal in the present invention.

FIG. 4 is the side view for the unprocessed soldering area of the terminal for the present invention.

FIG. 5 is the side view for the terminal for the present invention.

FIG. 6 is the solder ball formation for the terminal for the present invention.

FIG. 7 is the solder ball formation for another terminal for the present invention.

### DETAILED DESCRIPTION OF THE PREFERRED EMBODIMENT

With the attached figures, the detailed description of the present invention is given below:

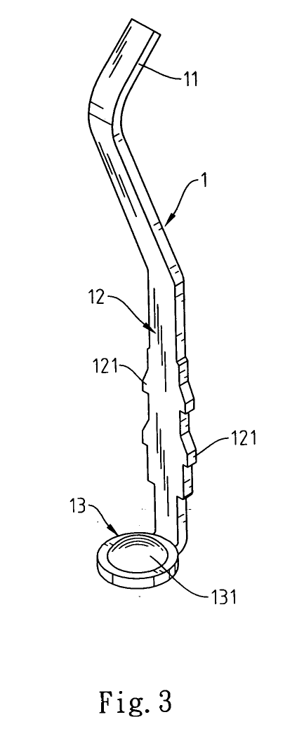

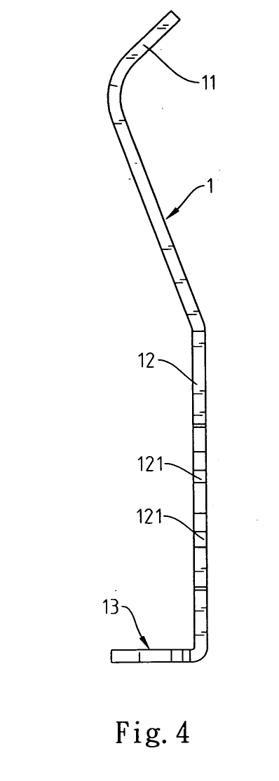

Please refer to FIG. 3 and FIG. 4. The solder ball formation structure for a terminal socket is mainly composed of a terminal 1 and a solder ball 2. The terminal has a contact end 11, an extension 12 and a soldering area 13. On top of the terminal 1, there is a contact end 11 that extends downward to an extension 12. There are locks 121 on the extension 12, which enable the terminal 1 to position into a connector socket. At the end of the terminal 1, the soldering area appears spherical and curves up after a treatment. Its size is appropriate for the curved surface 131 to facilitate the formation of solder balls.

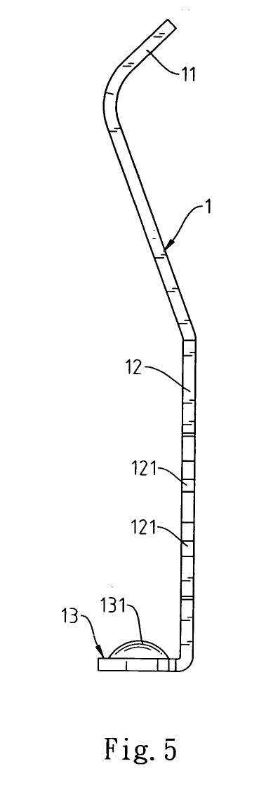

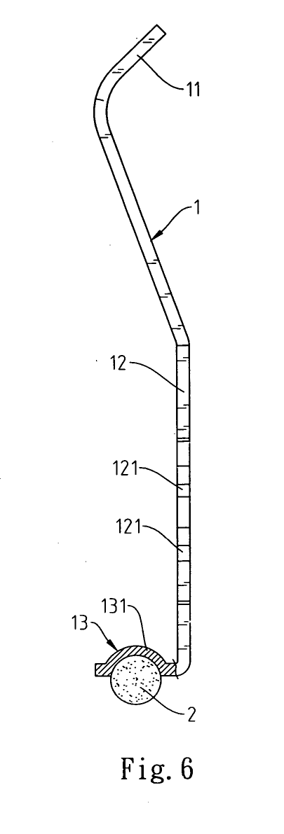

Please refer to FIG. 5 and FIG. 6. When the terminal 1 is treated to have a curved soldering area 13, a multiple number of terminals 1 descend simultaneously and the curved surfaces 131 of the soldering areas 13 touch the heated solder. Then the solder is transferred to the curved surface 131. Through increasing cohesive force by raising the terminal up, the solder balls 2 turn into near-spherical shape. The solder balls 2 also stick to the bottom of the extension 12. After the terminal 1 with a spherical solder ball 2 is inserted into a connector socket, the end soldering area 13 sticks out for a certain length. To level the attached solder balls 2, the solder balls 2 of these terminals 1 are subject to a leveling process, which when the connector is placed onto a circuit board assures all the solder balls receive the same amount of heat during. Thus, the connector terminal 1 can be soldered with good quality to a circuit board.

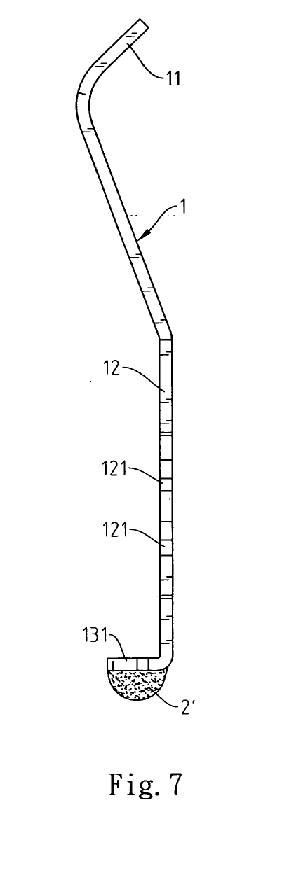

Further refer to FIG. 7. The soldering area 13′ can be a flat surface 131′. It is simpler than a curved surface. When the flat surface 131′ contacts the solder, the formed solder ball 2′ is semi-spherical and also achieves good soldering effect for connection to a circuit board.

In summary, the solder ball formation structure in the present invention waives the complicated soldering process, reduces the cost and also improves connector quality. All these advantages meet the patent filing requirement. Accordingly, a patent application is filed.

1. A solder ball formation structure for a terminal socket with a contact end on top and an extension towards bottom and terminal end combined with solder has features in: the soldering area at the terminal end appears spherical and curves up, so when the curved surface touches the heated solder, the solder is transferred to the curved surface and forms near-spherical solder ball through increasing cohesive force by raising the terminal up; and the solder ball sticks to the bottom of the soldering area.

2. The solder ball formation structure for a terminal socket as claimed in claim 1, wherein said the soldering area for the spherical solder ball is a circular flat surface.
